(19) United States
(12) Patent Application Publication
(10) Pub. No.: US 2015/0149542 A1
(43) Pub. Date: May 28, 2015

(54) SYSTEM AND METHODS FOR GENERATING AND PROVISIONING A PERSONALIZED GEO-FENCE

(71) Applicants: Chintan Jain, Hillsboro, OR (US); Greg Alan Cox, Portland, OR (US); Rui Kong, LAKE OSWEGO, OR (US)

(72) Inventors: Chintan Jain, Hillsboro, OR (US); Greg Alan Cox, Portland, OR (US); Rui Kong, LAKE OSWEGO, OR (US)

(21) Appl. No.: 14/092,827

(22) Filed: Nov. 27, 2013

(51) Int. Cl. H04L 12/58

(52) U.S. Cl. CPC H04L 51/32
USPC 709/204

(57) ABSTRACT

A system comprising a computer-readable storage medium storing at least one program and a computer-implemented method for provisioning a personalized geo-fence are described. Consistent with some embodiments, the method may include obtaining social network activity of a user from one or more social networks. The social network activity is analyzed to identify a concept for which the user has conveyed an affinity. A real-world location corresponding to the concept is identified and a personalized geo-fence is created for the user around the real-world location.

### TECHNICAL FIELD

This application relates to data processing. In particular, example embodiments may relate to systems and methods for providing a personalized geo-fence.

### BACKGROUND

A “geo-fence” is a virtual perimeter created around real-world geographic locations. Traditional geo-fence services provide merchants or other businesses with a capability to create a geo-fence around the merchant or business' location. When a user enters or exits a perimeter of one of these geo-fences with a location-aware device (e.g., a smartphone), a notification related to the location may be transmitted to the user's device. Such notifications are often used as a marketing tool to entice nearby users to patronize these locations. However, the traditional geo-fence services provide geo-fences at locations based solely on the merchant or business owner having opted into such a service. As a result, subscribers of the service receive notifications when entering and exiting certain locations irrespective of subscriber's interest in the particular location. Accordingly, the effectiveness of these notifications as a marketing tool is reduced because the majority of resulting notifications are simply ignored or overlooked by the subscribers that receive them.

### BRIEF DESCRIPTION OF THE DRAWINGS

Various ones of the appended drawings merely illustrate example embodiments of the present invention and cannot be considered as limiting its scope.

FIG. 1 is a network diagram depicting a network system having a client-server architecture configured for exchanging data over a network, according to an example embodiment.

FIG. 2 is a block diagram illustrating an example embodiment of multiple modules forming a marketplace application, which is provided as part of the network system of FIG. 1.

FIG. 3 is a block diagram illustrating an example embodiment of multiple modules forming a personalized geo-fence application, which is provided as part of the network system of FIG. 1.

FIG. 4 is a block diagram illustrating an example mobile device, consistent with some embodiments.

FIG. 5 is an interaction diagram depicting a personalized geo-fence provisioning interaction between a client, an application server, and a third party server, consistent with some embodiments.

FIG. 6 is a screenshot illustrating an example social network activity feed with example social network entries, consistent with some embodiments.

FIGS. 7A and 7B are diagrammatic representations of a personalized geo-fence, consistent with some embodiments.

FIG. 8 is an interface diagram depicting a notification presented on a client device of a user, consistent with some embodiments.

FIG. 9 is a flowchart illustrating an example method for generating and provisioning a personalized geo-fence, consistent with some embodiments.

FIG. 10 is a flowchart illustrating an example method for detecting a user entering a personalized geo-fence, consistent with some embodiments.

FIG. 11 is a flowchart illustrating an example method for generating and provisioning a personalized geo-fence, consistent with some alternative embodiments.

FIG. 12 is an interface diagram depicting an example personalized geo-fence view interface, consistent with some embodiments.

FIG. 13 is a diagrammatic representation of a machine in the example form of a computer system within which a set of instructions for causing the machine to perform any one or more of the methodologies discussed herein may be executed.

### DETAILED DESCRIPTION

Reference will now be made in detail to specific example embodiments for carrying out the inventive subject matter. Examples of these specific embodiments are illustrated in the accompanying drawings. It will be understood that they are not intended to limit the scope of the claims to the described embodiments. On the contrary, they are intended to cover alternatives, modifications, and equivalents as may be included within the scope of the disclosure. In the following description, specific details are set forth in order to provide a thorough understanding of the subject matter. Embodiments may be practiced without some or all of these specific details. In accordance with the present disclosure, components, process steps, and data structures may be implemented using various types of operating systems, programming languages, computing platforms, computer programs, and/or general purpose machines.

Aspects of the present disclosure describe systems and methods for provisioning a personalized geo-fence. Consistent with some embodiments, the method may include obtaining social network activity of a user from one or more social networks. The social network activity may include one or more social actions (e.g., a like, a tweet, a status update, a check-in, a pin, establishing a connection, or the like) performed by the user and published as an entry on one or more social networks (e.g., Facebook®, Twitter®, Google+®, Pinterest®, Svpply®). The social network activity is analyzed to identify a concept (e.g., brands, products, retailers, content, influencers, evangelists) for which the user has conveyed an affinity. A real-world location corresponding to the concept is identified and a personalized geo-fence is created for the user around the real-world location. For example, if a user “likes” the brand Nike® on Facebook®, a real-world location that sells the brand Nike® will be identified, and a personalized geo-fence that surrounds the real-world location will be generated for the user. Once the user enters the personalized geo-fence, a message may be transmitted to a device of the user. The message may include coupons, rewards, or other incentives that may be customized for the user based on stored information about the user.

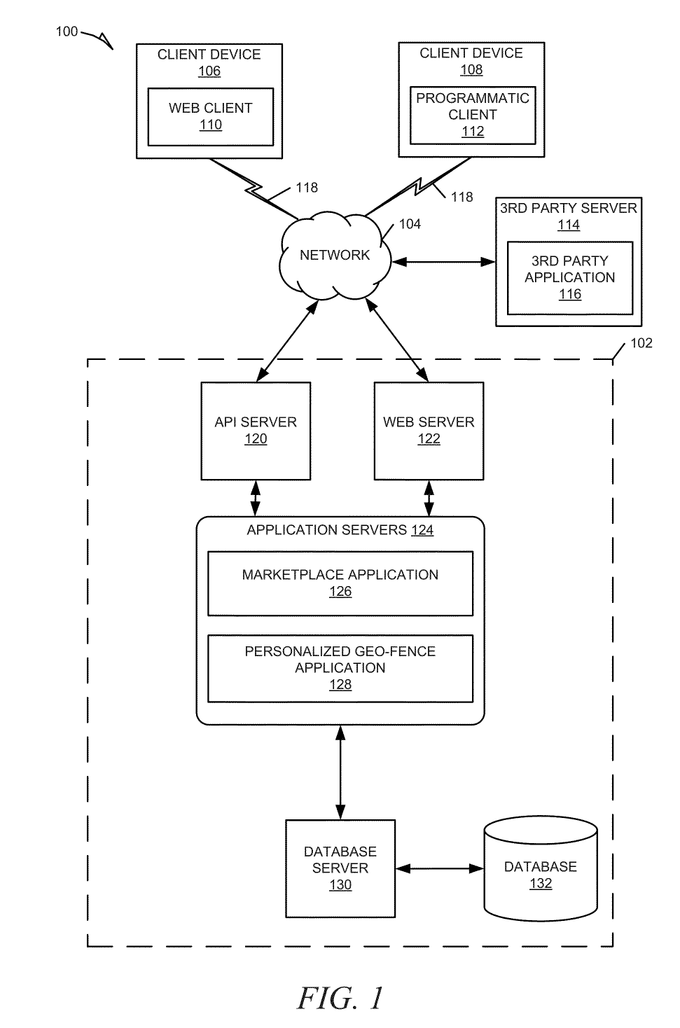

FIG. 1 is a network diagram depicting a network system 100, according to one embodiment, having a client-server architecture configured for exchanging data over a network. The network system 100 may include a network-based content publisher 102 in communication with client devices 106 and 108, and third party server 114. For example, the network-based content publisher 102 may be a network-based marketplace.

The network-based content publisher 102 may communicate and exchange data within the network system 100 that may pertain to various functions and aspects associated with the network system 100 and its users. The network-based content publisher 102 may provide server-side functionality, via a network 104 (e.g., the Internet), to one or more client devices (e.g., client devices 106 and 108). The one or more client devices 106, 108 may be operated by users that use the network system 100 to exchange data over a communication network 104. These transactions may include transmitting, receiving (communicating), and processing data to, from, and regarding content and users of the network system 100. The data may include, but are not limited to: images; video or audio content; user preferences; product and service feedback, advice, and reviews; product, service, manufacturer, and vendor recommendations and identifiers; product and service listings associated with buyers and sellers; product and service advertisements; auction bids; and transaction data, among other things.

In various embodiments, the data exchanged within the network system 100 may be dependent upon user-selected functions available through one or more client or user interfaces (UIs). The UIs may be associated with a client device, such as the client device 106 using a web client 110. The web client 110 may be in communication with the network-based content publisher 102 via a web server 122. The UIs may also be associated with the client device 108 using a programmatic client 112, such as a client application in communication with the network-based content publisher 102, or a third party server 114 (e.g., one or more servers or client devices 106, 108) hosting a third party application 116.

The client devices 106 and 108 may be any of a variety of types of devices. For example, the client devices 106 and 108 may a mobile device such as a smartphone such as an iPhone® or other mobile device running the iOS® operating system, the Android® operating system, a BlackBerry® operating system, the Microsoft® Windows® Phone operating system, Symbian® OS, or webOS®. Consistent with some embodiments, the client devices 106 and 108 may alternatively be a tablet computer, such as an iPad® or other tablet computer running one of the aforementioned operating systems. In some embodiments, the client device 106 and 108 may also be a personal digital assistant (PDA), a personal navigation device (PND), a handheld computer, a desktop computer, a laptop or netbook, a set-top box (STB) such as provided by cable or satellite content providers, a wearable computing device such as glasses or a wristwatch, a multimedia device embedded in an automobile, a global positioning system (GPS) device, a data enabled book reader, a video game system console such as the Nintendo Wii®, the Microsoft Xbox 360®, the Sony PlayStation 3®, or other video game system consoles.

The client devices 106 and 108 may interface via a connection 118 with the communication network 104 (e.g., the Internet or wide area network (WAN)). Depending on the form of the client device 106 and 108, any of a variety of types of connections 118 and communication networks 104 may be used. For example, the connection 118 may be code division multiple access (CDMA) connection, a Global System for Mobile communications (GSM) connection, or other type of cellular connection. Such a connection 118 may implement any of a variety of types of data transfer technology, such as single carrier radio transmission technology (1xRTT), evolution-data optimized (EVDO) technology, general packet radio service (GPRS) technology, enhanced data rates for GSM Evolution (EDGE) technology, or other data transfer technology (e.g., fourth generation wireless, 4G networks). When such technology is employed, the communication network 104 may include a cellular network that has a plurality of cell sites of overlapping geographic coverage, interconnected by cellular telephone exchanges. These cellular telephone exchanges may be coupled to a network backbone (e.g., the public switched telephone network (PSTN), a packet-switched data network, or to other types of networks).

In another example, the connection 118 may be wireless fidelity (Wi-Fi, IEEE 802.11x type) connection, a Worldwide Interoperability for Microwave Access (WiMAX) connection, or another type of wireless data connection. In such an embodiment, the communication network 104 may include one or more wireless access points coupled to a local area network (LAN), a WAN, the Internet, or other packet-switched data network. In yet another example, the connection 118 may be a wired connection, for example an Ethernet link, and the communication network 104 may be a LAN, a WAN, the Internet, or other packet-switched data network. Accordingly, a variety of different configurations are expressly contemplated.

FIG. 1 also illustrates the third party application 116 executing on the third party server 114 that may offer one or more services to users of the client devices 106 and 108. The third party application 116 may have programmatic access to the network-based content publisher 102 via the programmatic interface provided by an application program interface (API) server 120. In some embodiments, the third party application 116 may be associated with a vendor, a merchant, or any organizations that may conduct transactions with or provide services to the users of the client devices 106 and 108. For some example embodiments, the third party application 116 may correspond to a social network (e.g., Facebook®, Twitter®, Google+®, Pinterest®, Svpply®, or the like).

Turning specifically to the network-based content publisher 102, the API server 120 and a web server 122 are coupled to, and provide programmatic and web interfaces respectively to, one or more application servers 124. The application servers 124 may, for example, host one or more marketplace application 126, which may provide a number of marketplace functions and services to users that access the network-based content publisher 102. The application servers 124 may also host one or more personalized geo-fence application 128, which may be configured to generate and provision personalized geo-fences to users based on an analysis of social interactions on social networking sites. The application servers 124 may be coupled via these interfaces to the communication network 104, for example, via wired or wireless interfaces. The application servers 124 are, in turn, shown to be coupled to one or more database servers 130 that facilitate access to one or more databases 132. In some examples, the application servers 124 can access the databases 132 directly without the need for a database server 130. In some embodiments, the databases 132 may include databases both internal and external to the network-based content publisher 102.

While the marketplace application 126 and personalized geo-fence application 128 are shown in FIG. 1 to all form part of the network-based content publisher 102, it will be appreciated that, in alternative embodiments, personalized geo-fence application 128 may form part of a service that is separate and distinct from the network-based content publisher 102. Further, while the system 100 shown in FIG. 1 employs a client-server architecture, the present inventive subject matter is, of course, not limited to such an architecture, and could equally well find application in an event-driven, distributed, or peer-to-peer architecture system, for example. The various applications and modules of the application servers 124 may also be implemented as standalone systems or software programs, which do not necessarily have networking capabilities.

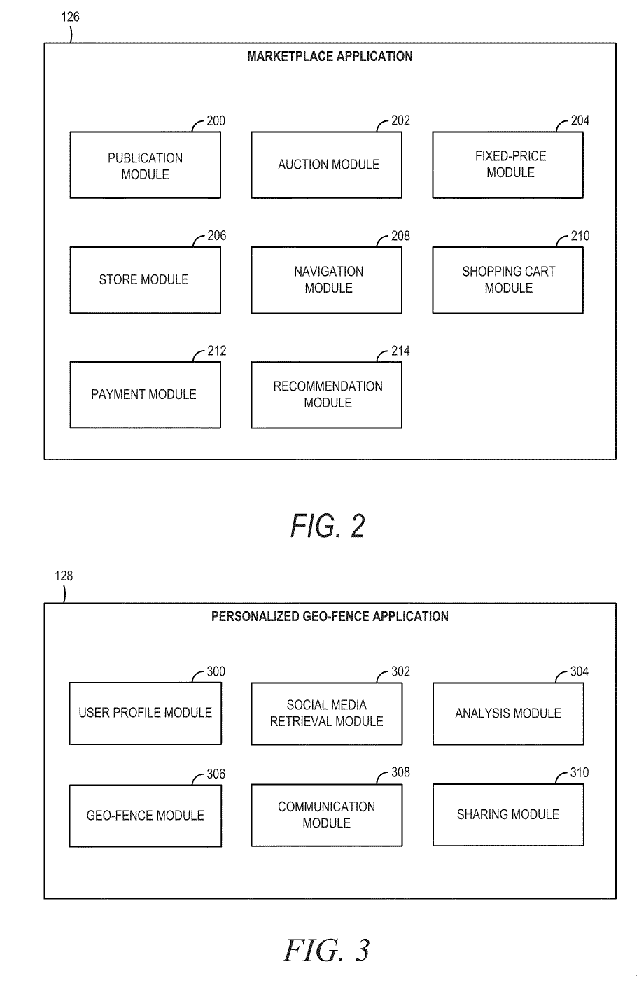

FIG. 2 is a block diagram illustrating an example embodiment of multiple modules forming the marketplace application 126, which is provided as part of the network system 100 of FIG. 1. The module of the marketplace application 126 may be hosted on dedicated or shared server machines that are communicatively coupled to enable communications between server machines. Each of the modules 200-214 are communicatively coupled (e.g., via appropriate interfaces) to each other and to various data sources, so as to allow information to be passed between the modules 200-214 of the marketplace application 126 or so as to allow the modules 200-214 to share and access common data. The various modules of the marketplace application 126 may furthermore access one or more databases 132 via the database servers 130. Further, while the modules 200-214 of FIG. 2 are discussed in the singular sense, it will be appreciated that in other embodiments multiple modules 200-214 may be employed.

The marketplace application 126 may provide a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace application 126 is shown to include at least one publication module 200 and one or more auction module 202, which support auction-format listing and price setting mechanisms (e.g., English, Dutch, Vickrey, Chinese, Double, Reverse auctions etc.). The auction module 202 may also provide a number of features in support of such auction-format listings, such as a reserve price feature whereby a seller may specify a reserve price in connection with a listing, and a proxy-bidding feature whereby a bidder may invoke automated proxy bidding.

A number of fixed-price modules 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store module 206 may allow sellers to group their product listings (e.g., goods and/or services) within a “virtual” store, which may be branded and otherwise personalized by and for the sellers. Such a virtual store may also offer promotions, incentives, and features that are specific and personalized to a relevant seller. In one embodiment, the listings and/or transactions associated with the virtual store and its features may be provided to one or more users.

Navigation of the network-based content publisher 102 may be facilitated by one or more navigation module 208. For example, a search module may, inter alia, enable keyword searches of listings published via the content publisher 102. A browser module may allow users via an associated UI to browse various category, catalogue, inventory, social network, and review data structures within the content publisher 102. Various other navigation modules 208 (e.g., an external search engine) may be provided to supplement the search and browsing module. Consistent with some embodiments, the results for keyword searches of listings published via the network-based content publisher 102 may be filtered to include only listings corresponding to social network connections of the user (e.g., indicated friends and family).

In one embodiment, electronic shopping cart modules 210 are used to create an electronic shopping cart used by users of the network-based content publisher 102 to add and store products (e.g., goods and services) listed by the store module 206. The electronic shopping cart module 210 may also be used to “check out,” meaning a user may purchase products in the electronic shopping cart. The electronic shopping cart module 210 may facilitate the transactions by automatically finding the products in the electronic shopping cart across at least one or all of a predefined set of vendors, a comparison shopping site, an auction site, etc. In various embodiments, the selection criteria for which vendor or vendors to purchase from may include, but is not limited to, criteria such as lowest cost, fastest shipping time, preferred or highest rated vendors or sellers, or any combination thereof.

As illustrated in FIG. 2, the marketplace application 126 may include one or more payment module 212 that may provide a number of payment services and functions to users. The payment module 212 may allow users to accumulate value (e.g., in a commercial currency, such as the U.S. dollar, or a proprietary currency, such as “points”) in accounts, and then later to redeem the accumulated value for products (e.g., goods or services) that are made available via the payment module 212. For some example embodiments, the payment module 212 generally enables transfer of values (e.g., funds, reward points, etc.) from an account associated with one party (e.g., a sender) to another account associated with another party (e.g., a receiver).

As illustrated in FIG. 2, the marketplace application 126 may include one or more recommendation module 214, which may provide recommendation services and functions to users. In some embodiments, the recommendation module 214 may receive requests for recommendations, and, in turn, provide a recommendation to the user based on information contained in the user's corresponding user profile. In some embodiments, the recommendation module 214 may automatically generate and provide a recommendation based on the activity of the user. The recommendations provided by the recommendation module 214 may contain one or more items (e.g., products offered for sale, articles, blogs, movies, social network connections, etc.) that may potentially interest a user. The recommendations may, for example, be based on previous products purchased by the user or a social network connection of the user, a web page viewed by the user, or an item given favorable feedback by the user or a social connection of the user.

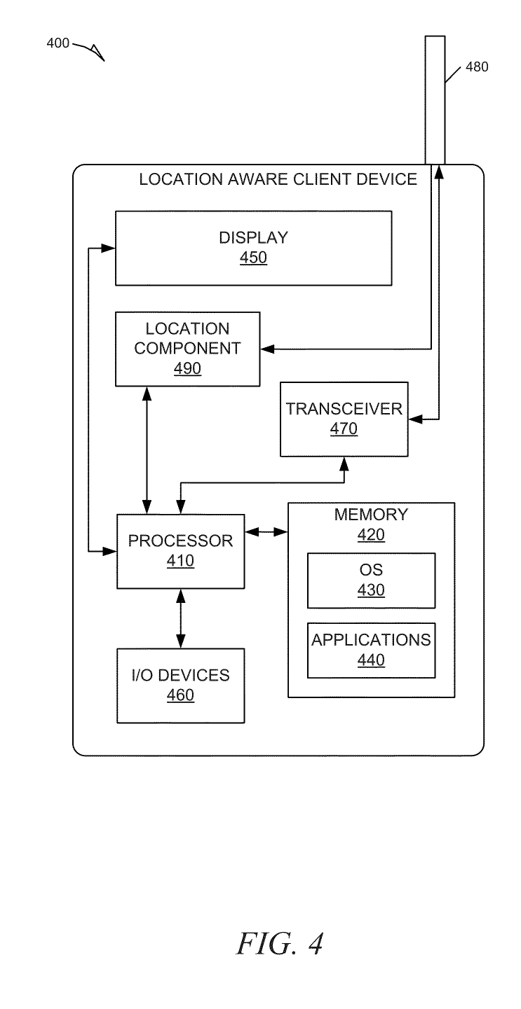

FIG. 3 is a block diagram illustrating an example embodiment of multiple modules forming the personalized geo-fence application 128, which is provided as part of the network-based content publisher 102. The personalized geo-fence application 128 is shown as including one or more user profile module 300, social media retrieval module 302, analysis module 304, geo-fence module 306, communication module 308, and sharing module 310, all configured to communicate with each other (e.g., via a bus, shared memory, a switch, or application programming interfaces (APIs)). The various modules of the personalized geo-fence application 128 may, furthermore, access one or more databases 132 via the database servers 130, and each of the various modules of the personalized geo-fence application 128 may each be in communication with one or more of the third party application 116. Further, while the modules of FIG. 3 are discussed in the singular sense, it will be appreciated that in other embodiments multiple modules may be employed.

Consistent with some embodiments, the user profile module 300 may be configured to generate and maintain a user profile for each user of the network-based content publisher 102. Each user profile may be stored and maintained in the database 132. Each user profile may comprise user data that describes aspects of a particular user. The user data may include demographic data, user preferences, user activity, and user account information. Accordingly, the user profile module 300 may be configured to monitor, track, and record the activities and interactions of a user, using one or more devices (e.g., client device 106), with the various module of the network system 100. The user profile module 300 may store each user session as an activity set and maintain each activity set as part of the user data. Accordingly, in some embodiments, the user data may include past keyword searches that users have performed, web pages viewed by each user, products added to a user wish list or watch list, products added to an electronic shopping cart, and products that the users own. In some embodiments, the user preferences may be inferred by the user profile module 300 from the user activity.

In some embodiments, the user profile module 300 may monitor and store the activity of the user associated with the searching and browsing of listings published via the marketplace application 126. Accordingly, the user profile may also include a transaction history of the user. Transaction history may include information related to transactions for items or services (collectively referred to as “products”) offered for sale by merchants via marketplace application 126. The transaction history information may, for example, include a description of a product purchased by the user, an identifier of the product, a category to which the product belongs, a purchase price, a quantity, or a number of bids.

The demographic data included as part of the user profile may include information describing one or more characteristics of a user. Demographic data may, for example, include gender, age, location information, employment history, education history, contact information, familial relations, or user interests.

The user account information included in each user profile may, for example, include private financial information of the user such as account number, credential, password, device identifier, user name, phone number, credit card information, bank information, or other financial information which may be used to facilitate online transactions by the user.

In some embodiments, the user profile may also include a list of social network connections of the user. The social network connections of a user may be retrieved via an API from one or more social networks. For purposes of the present disclosure, a social network “connection”, also referred to as being “connected” on a social network, may include both a bi-lateral agreement between members of the social network as well as situations in which there is only a unilateral acknowledgement of the “connection.” In the bi-lateral agreement situation, both members of the “connection” acknowledge the establishment of the connection (e.g., friends). Similarly, in the unilateral acknowledgement situation, a member may elect to “follow” or “watch” another member, however, such situations may not call for approval by the member that is being followed or watched.

As illustrated in FIG. 3, the personalized geo-fence application 128 may include one or more social media retrieval module 302. The social media retrieval module 302 may be configured to retrieve and track social network activity from one or more social networks. For purposes of the present disclosure, “social network activity” collectively refers to one or more social actions performed by users on a social network. Social actions may be published as one or more social network entries (e.g., text and image posts, links, messages, notes, invitations, etc.) that may be shared by users on social networks. Such social network activities may include entries that are intended for the public at large as well as entries intended for a particular social network connection or group of social network connections. Depending on the social network, the social network activity may include, for example, social actions such as a status update, a comment, a tweet, a pin, a like, a favorite, an up-vote, a+1, a share, an activity feed post, a wall post, or a check-in. For purposes of the present disclosure, a “check-in” refers to a service provided by a social network that allows users to “check-in” to a physical space and share their location with other users of the social network. In some embodiments, a user may check-in to a specific location by sending a text message to the relevant social network service. Consistent with some embodiments, users may check-in to a specific location by using a mobile application provided by the social network on a client device (e.g., client device 106). The social network mobile application may use the GPS functionality of the client device 106 to find the current location of the user and allow the user to share this information with other users of the social network. Consistent with some embodiments, social actions may also include a life change status of a user such as change of relationship status from single to engaged, or from engaged to married, a pregnancy, a birth of a child or the like.

The social media retrieval module 302 may obtain social network activities via publically accessible APIs provided by each of the one or more social networks. In some embodiments, the social media retrieval module 302 may obtain social network activities of users of the network-based content publisher 102, and maintain each social network activity as part of the user data comprising each of the respective user's profiles, which are stored in databases 132. In some embodiments, the social media retrieval module 302 may obtain social networks entries generated by connections of users of the network-based content publisher 102, and may maintain the social network activities of each connection as part of the user data comprising each of the respective user's profiles, which are stored in databases 132.

As illustrated in FIG. 3, the personalized geo-fence application 128 may include one or more analysis module 304, which may be used to analyze the social network activity obtained by the social media retrieval module 302. The analysis module 304 may analyze the social network activity retrieved by the social media retrieval module 302 to identify concepts (e.g., products, brands, merchants, content, etc.) for which users have conveyed an affinity. To this end, the analysis module 304 may analyze social network entries to identify certain social actions that may be indicative of an affinity for a particular concept. For example, the analysis module 304 may determine that a user has an affinity for particular electronics retailer based on the user having “liked” that particular electronics retailer on Facebook®. In another example, the analysis module 304 may determine that a user has an affinity for ice cream based on the user having repeatedly checked-in at multiple ice cream parlors within a certain time period. In yet another example, the analysis module 304 may determine that a user has an affinity for wedding items and related clothing based on the user having a relationship status change from “single” to “engaged”.

Consistent with some embodiments, the analysis module 304 may be configured to identify keywords from social network entries that are indicative of an affinity for a particular concept (hereinafter referred to as “affinity keywords”). For example, a social network entry stating “I love Kiwi Electronics!” would be indicative of an affinity for “Kiwi Electronics.” In this example, the analysis module 304 may identify the term “love” as an affinity keyword that is indicative of the user's affinity. In some embodiments, the affinity keywords identified by the analysis module 304 may be terms or phrases that are indicative of a desire of a user to purchase a particular product. For example, a social network entry stating, “I want to buy the new X-Sphere One!!” would be indicative of the user's desire to purchase a new X-Sphere One and thus may be indicative of the user's affinity for the X-Sphere One.

In some embodiments, the identification of the affinity keywords performed by the analysis module 304 may comprise performing natural language processing for each entry to mine terms and phrases from each entry that are indicative of an affinity for a concept. In turn, the terms and phrases extracted from these entries may be compared to a database 132 of known terms or phrases that are used to express an affinity for concepts.

In some embodiments, the analysis module 304 may analyze social network entries that may include one or more images. Consistent with these embodiments, the identifying of concepts for which a user has an affinity may include identifying one or more products from images included in social network entries. The identification of the one or more products may include performing image recognition on the one or more images to identify one or more products from the one or more images. The analysis module 304 may use the identified products (e.g., identified by language processing or image recognition) to identify a concept for which the user has an affinity. In some embodiments, the determination that the user has an affinity for a particular concept may be based on a predetermined number of products appearing in images included in social network entries shared by a user. For example, the analysis module 304 may identify Hermes® as a concept for which a user has an affinity if the user often posts images of Hermes® purses on a particular social network. Further, in this example, the analysis module 304 may identify the broader concept of “purses” as a concept for which the user has an affinity.

In some embodiments, the analysis module 304 may analyze social network activities of the connections of a particular user to identify concepts for which the user may have an interest. The analysis performed by the analysis module 304 operates under the assumption that a user may be interested in concepts that his connections have conveyed an interest in or affinity for. Accordingly, the identification of concepts for which the user may have an interest may be performed in accordance with the methodologies discussed herein in relation to identifying concepts for which a user has an affinity with the exception that the social network activity being analyzed is of the connections of the particular user and not the social network activity of the user himself. For example, the analysis module 304 may determine that a user may be interested in a particular bar based on a group of connections of the user having checked-in to the particular bar.

Consistent with some embodiments, the analysis module 304 may be configured to analyze the information about the user (e.g., a transaction history) maintained in the user's corresponding user profile to determine that the user has an affinity for a particular concept. For example, if a user has performed a search for Apple® products (e.g., using marketplace application 126) and has purchased multiple Apple® products (e.g., using marketplace application 126), the analysis module 304 may determine that the user has an affinity for the Apple® brand.

As illustrated in FIG. 3, the personalized geo-fence application 128 may include one or more geo-fence module 306, which are responsible for generating a personalized geo-fence. The geo-fence module 306 may generate the personalized geo-fence for a user in response to the analysis module 304 identifying a concept for which the user has conveyed an interest. Each personalized geo-fence generated by the geo-fence module 306 may be stored in a database (e.g., database 132) and may be maintained as part of the user profile (e.g., generated and maintained by the user profile module 300) of the user for which the personalized geo-fence has been generated.

The personalized geo-fence is a virtual perimeter surrounding a real-world location (e.g., a physical location or building) corresponding to one or more concepts for which the user has conveyed an affinity. In some embodiments, the virtual perimeter may correspond to the actual perimeter of the real-world location. In other embodiments, the virtual perimeter may be generated to be more expansive than simply the perimeter of the real-world location by creating a radius around the real-world location such that parking lots, driveways, entrance gates, sidewalks or other features of the real-world locations may be included within the personalized geo-fence. The virtual perimeter defining the personalized geo-fence may also be expanded so as to include various modes of ingress to the real-world location.

The geo-fence module 306 may be configured to locate real-world locations corresponding to the identified concepts. In some embodiments, the real-world locations may be identified based on known associations with particular concepts (e.g., information that may be obtained from one or more third-party servers, from the World Wide Web, or from other related databases of information). In instances in which the concept for which the user has conveyed an affinity is a brand, product, or category of products, the geo-fence module 306 may locate retail locations offering the particular brand, product, or category of products for sale. For example, the analysis module 304 may identify a user's conveyed affinity for ear-bud headphones, and in response the geo-fence module 306 may locate a nearby electronics retailer offering ear-bud headphones for sale, and generate a personalized geo-fence for the user around the nearby electronics retailer. In another example, the analysis module 304 may identify a user's conveyed affinity for the Apple® brand, and in response the geo-fence module 306 may locate a nearby Apple Store®, and generate a personalized geo-fence for the user around the nearby Apple Store®.

In some embodiments, the geo-fence module 306 may take into account the location of the user in identifying real-world locations corresponding to concepts for which the user has conveyed an affinity. To this end, the geo-fence module 306 may be configured to receive geo-location information from a device of the user (e.g., client device 106, or client device 108). The real-world locations located by the geo-fence module 306 may correspond to the closest of such locations to the location of the user (e.g., as established by the geo-location received from the user's device), or in some embodiments, locations that are within a pre-defined distance of the user. In some embodiments, the user profile module 300 may allow users to set this pre-defined distance.

The geo-fence module 306 may also use the geo-location information received from a location aware device 106, 108 of the user to detect when the user has entered the virtual perimeter of the personalized geo-fence. The entering of a user into a personalized geo-fence (also referred to as “breaking” or “breaching” a geo-fence) triggers the communication of a message (e.g., a notification) to a client device 106, 108 of the user, the location of which corresponds to the user's location. To this end, the personalized geo-fence application 128 may include one or more communication module 308, which may facilitate communications transmitted to and between users. In some embodiments, the communication module 308 may be used for generation and delivery of messages to users of the network-based content publisher 102. Such a message may include a notification that the user is within a certain distance of the real-world location. Further, such messages may include coupons, rewards, or other incentives and may be customized according to information about users maintained as part of each user's respective user profile.

In some embodiments, the communication module 308 may be used for generation and delivery of messages to a merchant. Such messages may notify a merchant that a user, who has conveyed an interest for a concept related to the offerings of the merchant, has entered a geo-fence corresponding to the merchant's real-world location.

Respective communication modules 308 may utilize any one of a number of message delivery networks and platforms to deliver messages to users. For example, the communication module 308 may deliver push notifications (e.g., via a pertinent push notification service), electronic mail (e-mail), instant message (IM), short message service (SMS), text, facsimile, or voice (e.g., Voice over IP (VoIP)) messages via the wired (e.g., the Internet), plain old telephone service (POTS), or wireless (e.g., mobile, cellular, WiFi, WiMAX) networks.

As illustrated in FIG. 3, the personalized geo-fence application 128 may include one or more sharing module 310, which may provide the ability for users to share personalized geo-fences with other users of the network-based content publisher 102. The sharing module 310 may generate a personalized geo-fence view interface that includes each of the personalized geo-fences of the user. The personalized geo-fence view interface may include buttons to provide the user with the ability to view, edit, create and delete personalized geo-fences. In addition, the personalized geo-fence view interface may include a share button to share a personalized geo-fence on one or more social networks. Consistent with some embodiments, user selection of the share button may cause to the sharing module 310 in conjunction with the communication module 308 to generate an entry on behalf of the user to be published on one or more social networks. In some embodiments, the user must provide authorization for the communication module 308 to post the entry on his behalf. Once shared, a personalized geo-fence may be added by other users to their user profile such that when one of the other users enters the personalized geo-fence a message may be communicated by the communication module 308 to the other users. Consistent with some embodiments, the user may be incentivized to share personalized geo-fences with others. For example, a first user may be provided with rewards or loyalty points for each additional user that adds the first user's personalized geo-fence to their user profile. The rewards and loyalty points may be accumulated in a user account and may eventually be redeemed at the real-world location corresponding to the personalized geo-fence.

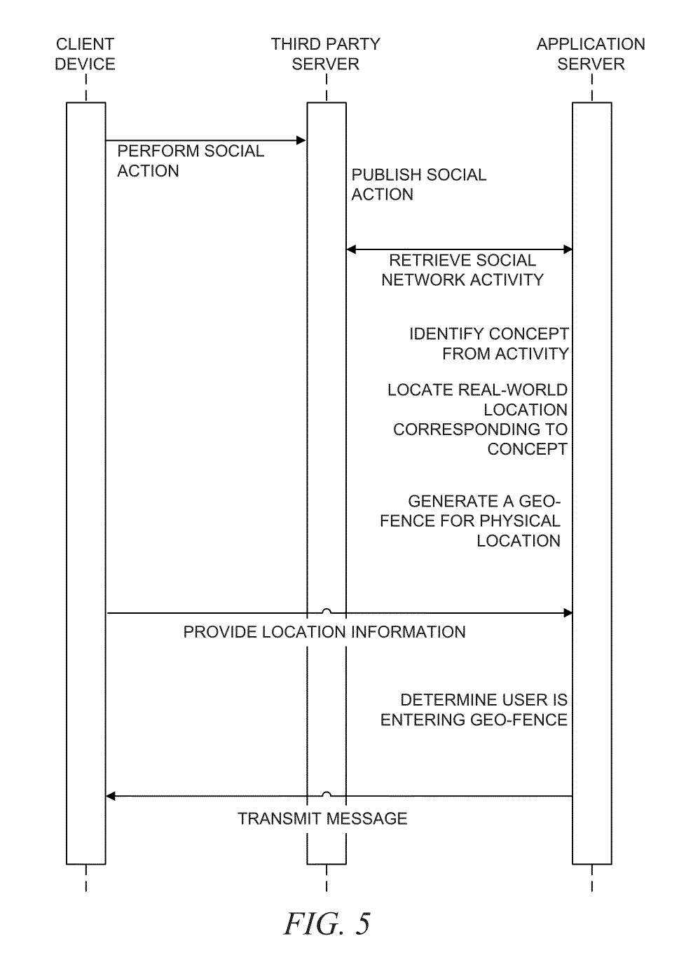

FIG. 4 is a block diagram illustrating a location aware client device 400, which may correspond to client device 106 or client device 108, consistent with some embodiments. The location aware client device 400 may, for example, be a smartphone such as an iPhone® or other mobile device. The location aware client device 400 may also be a tablet computer such as the iPad® or other similar device. The location aware client device 400 may include a processor 410. The processor 410 may be any of a variety of different types of commercially available processors suitable for mobile devices (e.g., an XScale architecture microprocessor, a microprocessor without interlocked pipeline stages (MIPS) architecture processor, or another type of processor). A memory 420, such as a random access memory (RAM), a Flash memory, or other type of memory, is typically accessible to the processor 410.

The memory 420 may store instructions for execution by the processor 410 for causing the location aware client device 400 to perform specific tasks. For example, the memory 420 may be adapted to store an operating system (OS) 430. Depending on the particular type of the location aware client device 400, the OS 430 may, for example, be the iOS® operating system, the Android® operating system, a BlackBerry® operating system, the Microsoft® Windows® Phone operating system, Symbian® OS, or webOS®. Further, such instructions may relate to operations performed by application 440 (commonly known as “apps”) stored in memory 420. One example of an application 440 is a mobile browser application that displays content, such as a web page or a user interface using a browser. The application 440 may also include social application such as Facebook®, Twitter®, Google+®, Pinterest®, of Svpply® in communication with an applicable third party server. The application 440 may also include a mobile marketplace application for viewing, purchasing, and selling products through marketplace application 126. The application 440 may also include a mobile location enabled application that may provide location based services (e.g., real-world location check-in) to a user.

The processor 410 may be coupled, either directly or via appropriate intermediary hardware, to a display 450 and to one or more input/output (I/O) devices 460, such as a keypad, a touch panel sensor, a microphone, a speaker, a camera, and the like. Similarly, in some embodiments, the processor 410 may be coupled to a transceiver 470 that interfaces with an antenna 480. The transceiver 470 may be configured to both transmit and receive cellular network signals, wireless data signals, or other types of signals via the antenna 480, depending on the nature of the location aware client device 400. In this manner, the connection 118 with the network 104 may be established.

Consistent with some embodiments, the location aware client device 400 may include a location component 490 for determining a location of the location aware client device 400. In some embodiments, the location component 490 may correspond to a GPS transceiver that may make use of the antenna 480 to communicate GPS signals with a GPS satellite. The location component 490 may also be configured to determine a location of the location aware client device 400 by using an internet protocol (IP) address lookup or by triangulating a position based on nearby mobile communications towers. The location component 490 may be further configured to store a user-defined location in memory 420. In some embodiments, a mobile location enabled application may work in conjunction with the location component 490 and the transceiver 470 to transmit the location of the location aware client device 400 to the application server 124 or third party server 114 via antenna 480 for the purpose of identifying the location of a user operating the location aware client device 400.

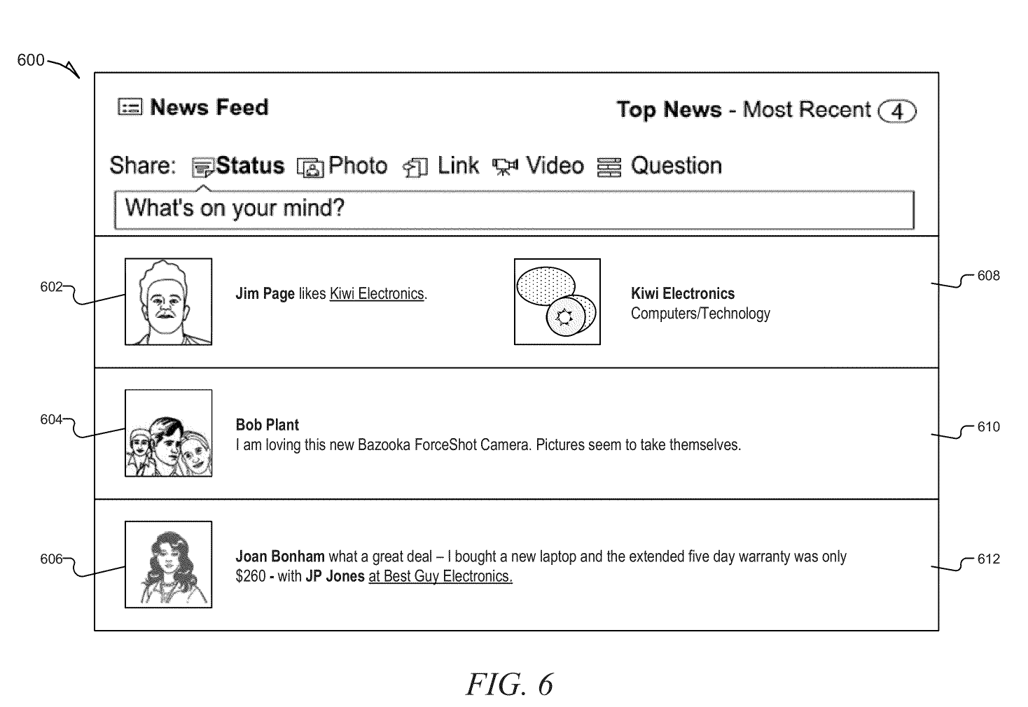

FIG. 5 is an interaction diagram depicting a personalized geo-fence provisioning interaction between a client device, an application server, and a third party server 114, consistent with some embodiments. The client device illustrated in FIG. 5 may, for example, correspond to client device 108. The third party server 114 illustrated in FIG. 5 may, for example, correspond to a server hosting a social network (e.g., Facebook®). Further, the application server illustrated in FIG. 5 may, for example, correspond to the application server 124.

As shown, a user of the client device 108 performs a social action enabled by a social network application executing on the client device 108 that is in communication with the third party server 114. The social action performed by the user is such that the user conveys an affinity for a particular concept. The social network hosted by the third party server 114 may then publish the user's social action as a social network entry that may be viewable by the connections of the user or select group thereof. The social network hosted by the third party server may provide an API to allow the application server to retrieve the social network activities (e.g., a plurality of social network entries including the above referenced social network entry) of the user of the client device 108.

Once the social network activities of the user have been retrieved, the application server 124 may identify the concept for which the user conveyed an affinity for from the initial social action. The application server 124 may then locate a real-world location corresponding to the concept and generate a personalized geo-fence for the user at the real-world location. The client device 108 may be in constant communication with the application server 124 to provide the location of the client device 108, which consequently is the location of the user, to the application server 124. The user, with the client device 108 in hand (or otherwise on the person of the user), may enter the geo-fence. Using the location information provided by the client device 108, the application server 124 may determine that the user is entering the personalized geo-fence, and in response the application server may transmit a message (e.g., a notification, text, email, etc.) to the client device 108 in accordance with the methodologies discussed herein.

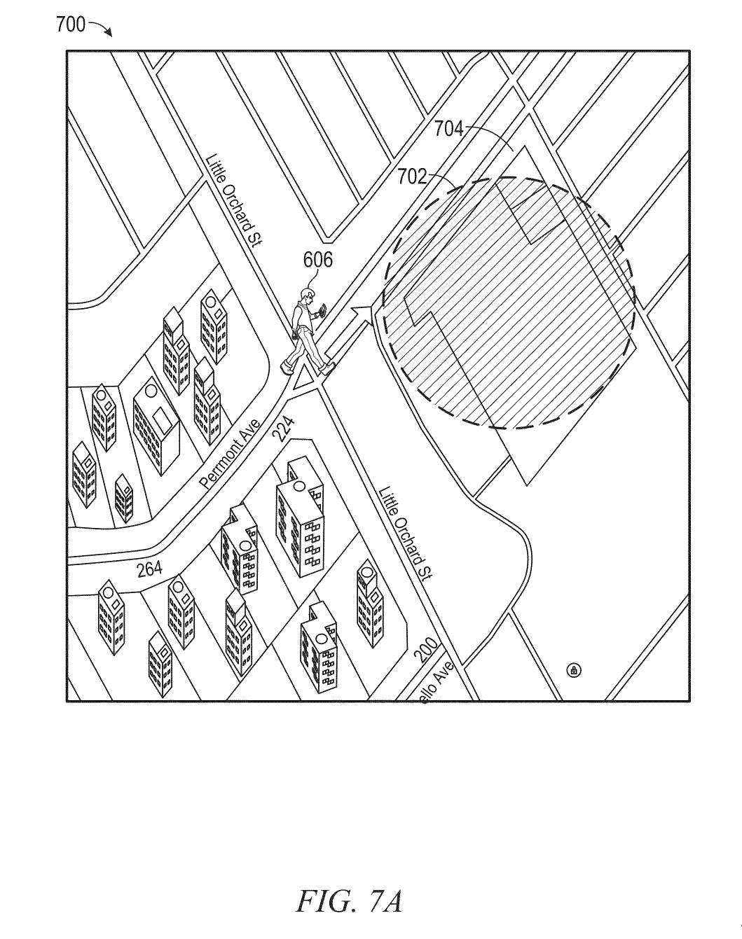

FIG. 6 is a screenshot illustrating an example social network activity feed 600 including example social network entries, consistent with some embodiments. As shown in FIG. 4, the activity feed 600 includes a subset of the social network activity of users 602, 604, and 606 that respectively includes social network entries 608, 610, and 612. Each of the social network entries 608, 610, and 612 are representative of example social actions that may be performed by users of the social networks. In particular, the social network entry 608 corresponds to the social action of the “like.” The social network entry 610 corresponds to the social action of a “status update.” The social network entry 612 corresponds to the social action of a “check-in.”

The social media retrieval module 302 may retrieve the entries 608, 610, and 612 for analysis by the analysis module 304. Each of the social network entries 608, 610, and 612 are examples of social network entries that may be used by the analysis module 304 to determine that the users 602, 604, and 606 have an affinity for the respective concepts referenced therein. Specifically, from the social network entry 608, the analysis module 304 may determine that the user 602 has an affinity for the “Kiwi Electronics” because the social action of “liking” is an explicit indication of an affinity for the “liked” concept or subject matter. Similarly, from social network entry 610 the analysis module 304 may determine that user 604 has an affinity for the “Bazooka” brand of cameras based on identifying a derivation of the affinity keyword “love” in the text of social network entry 610. From the social network entry 612 the analysis module 304 may determine that user 606 has an affinity for “Best Guy Electronics” based on the user 606 having checked-in to a real-world “Best Guy Electronics” location.

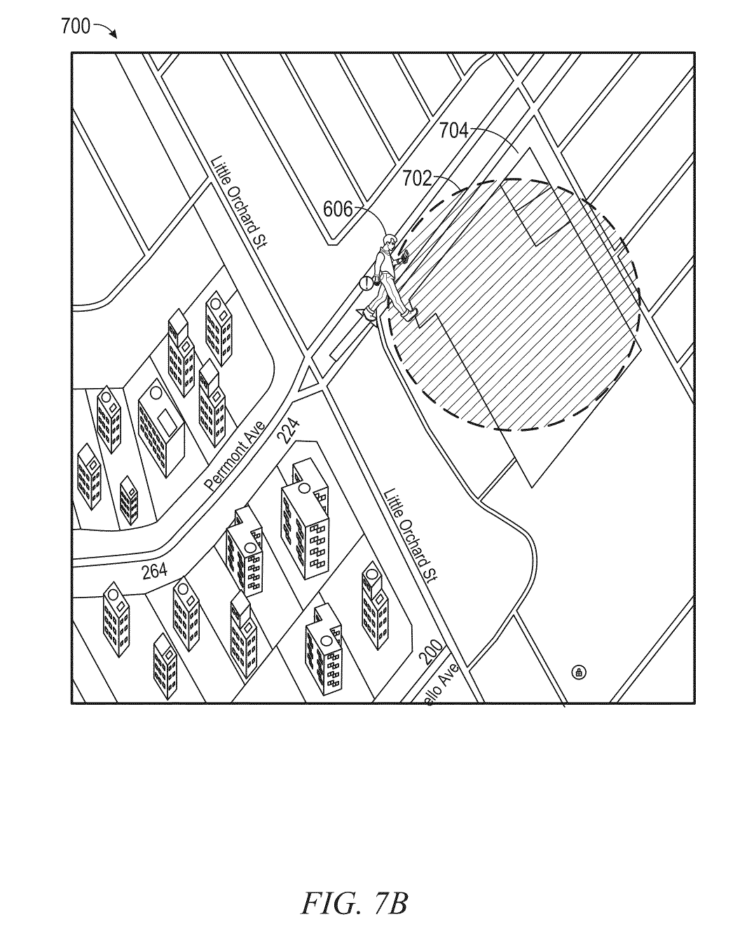

FIGS. 7A and 7B are diagrammatic representations of a personalized geo-fence, consistent with some embodiments. In particular, FIGS. 7A and 7B illustrate a map view 700 including a personalized geo-fence 702 surrounding a real-world location 704. The real-world location 704 corresponds to the concept for which the user 606 conveyed an affinity for in the social network entry 612. More specifically, the real-world location 704 corresponds to “Best Guy Electronics.” The personalized geo-fence 702 may be generated by the geo-fence module 306 in response to the analysis module 304 identifying the concept and locating the corresponding real-world location 704 of Best Guy Electronics.

As illustrated in FIG. 7A, the user 606 is outside of the personalized geo-fence 702 in motion toward the personalized geo-fence 702. The client device 108 (not shown) may be carried by the user 606 while in motion toward the personalized geo-fence 702. A mobile location enabled application may be executing on the client device 108 to provide the location of the user 606 to the personalized geo-fence application 128.

As illustrated in FIG. 7B, the user 606 has entered the personalized geo-fence 702. The geo-fence module 306 may detect that the user 606 has entered the personalized geo-fence 702 based on the location information received from the client device 108. In response to determining that the user 606 has entered the personalized geo-fence 702, the communication module 308 may generate and deliver one or more messages (e.g., notifications) to the client device 108.

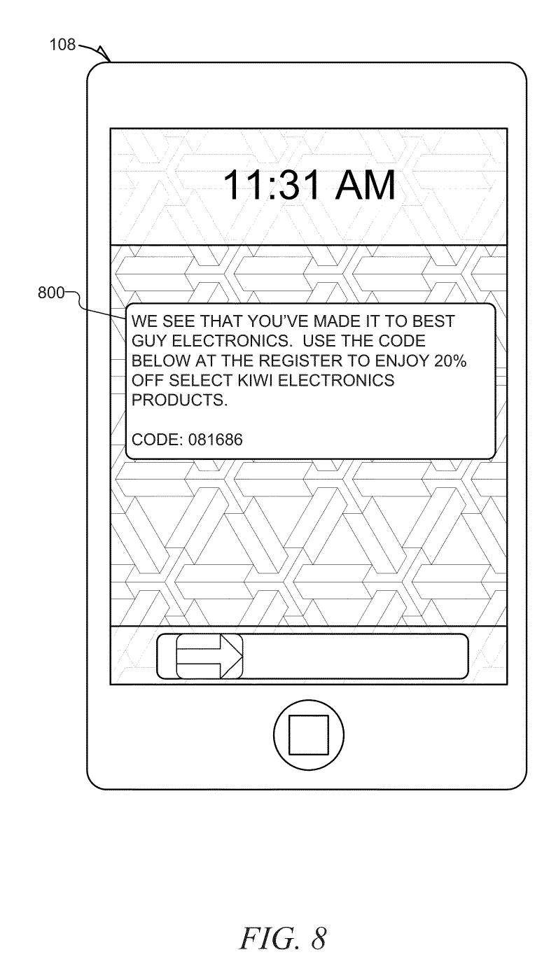

FIG. 8 is an interface diagram depicting a notification presented on a client device of a user, consistent with some embodiments. In particular, FIG. 8 illustrates a notification 800 displayed on the client device 108 of the user 606. The notification 800 may be transmitted to the client device 108 in response to detecting that the user 606 has entered the personalized geo-fence 702, as illustrated in FIG. 7B. As illustrated in FIG. 8, the notification 800 may indicate that the user 606 is at least near the real-world location 704. The notification 800 may further include one or more coupons, rewards, or other incentives related to the real-world location 704. Specifically, the notification 800 includes a unique coupon code that may be redeemed by the user 606 at the real-world location 704, which corresponds to a concept (e.g., “Best Guy Electronics”) for which the user 606 had previously conveyed an affinity.

It should be appreciated that the content of notification 800 is presented for illustrative purposes only, and in other embodiments, such notifications may include a myriad of varied coupons, rewards, or other incentives that may be applicable at a real-world location 704 for which a personalized geo-fence 702 has been entered, or may be applicable at an electronic marketplace hosted by application servers 124 or third party server 114. Further, in some embodiments, the particular varied coupons, rewards, or other incentives provided to a user 606 may be specifically tailored for the user based on the preferences of the user 606 preferences and other information about the user 606 maintained as part of a user profile. Also, although FIG. 8 illustrates a message being delivered by the communication module 308 via an applicable push notification service, the communication module 308 is, of course, not limited to such a delivery platform, and may in other embodiments utilize any one of a number of message delivery networks and platforms to deliver messages to the client devices 108 of users 606.

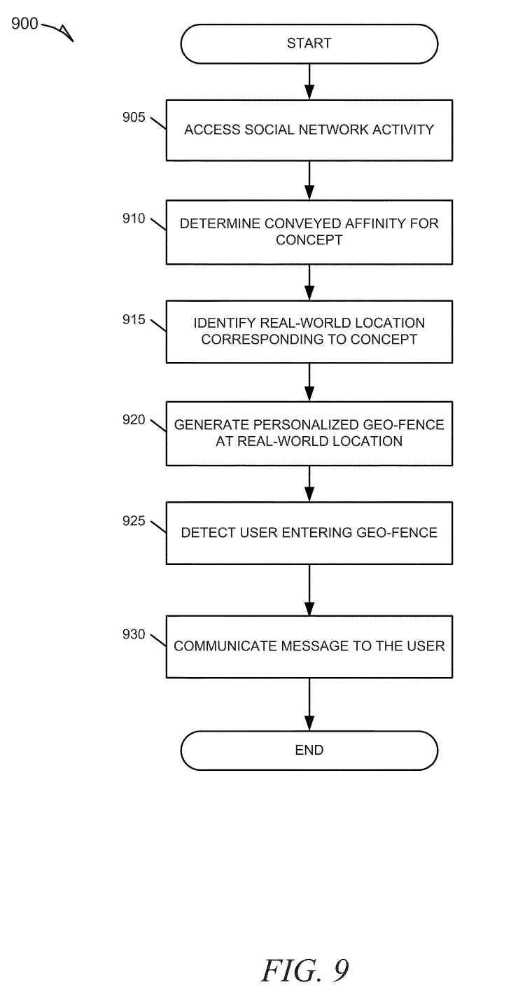

FIG. 9 is a flowchart illustrating an example method 900 for generating and provisioning a personalized geo-fence, consistent with some embodiments. The method 900 may be embodied in computer-readable instructions for execution by one or more processors such that the steps of the method 900 may be performed by the application server 124 and, in particular, the module 300-310 comprising the personalized geo-fence application 128.

As shown in FIG. 9, at operation 905, the social media retrieval module 302 may access social network activities of a user on one or more social networks. Consistent with some embodiments, the user's social network activities may include interactions with social networking sites using a mobile social application executing on a client device of the user (e.g., the client devices 106 and 108). The social network activity may include one or more social actions published as an entry on one or more social networks. The social network activity may be publicly accessible and available to be retrieved by the social media retrieval module 302. Alternatively, a user may grant the personalized geo-fence application 128 permission to access their social networking activity to learn more about the user.

At operation 910, the analysis module 304 may analyze the retrieved social network activity to determine that the user has conveyed an affinity for a particular concept. In some embodiments, the determination that the user has conveyed an affinity for a particular concept may be based on identifying one or more social network entries included in the social network activity in which the user explicitly conveys an affinity for a particular subject (e.g., a “like”). In some embodiments, the determination that the user has conveyed an affinity for a particular concept may be based on identifying one or more social network entries included in the social network activity in which the user implicitly conveys an affinity for a particular subject (e.g., a “check-in”). In some embodiments, the determination that the user has conveyed an affinity for a particular concept may include identifying one or more affinity keywords used in reference to the concept in one or more social network entries of the user.

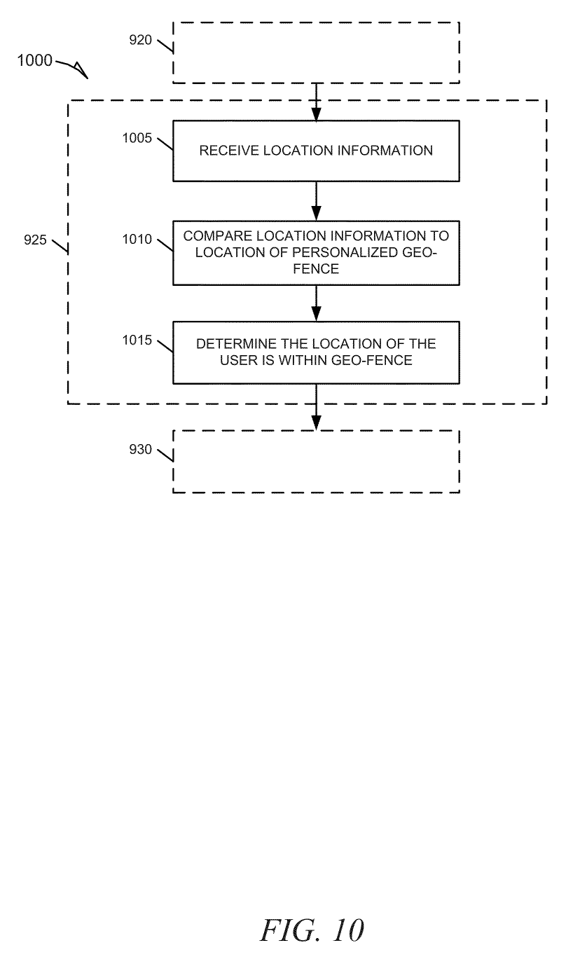

At operation 915, the geo-fence module 306 may identify at least one real-world location corresponding to the concept, and generate a personalized geo-fence around the at least one real-world location at operation 920. At operation 925, the geo-fence module 306 may detect that the user is entering the personalized geo-fence. The detecting that the user is entering the personalized geo-fence may be based on information received from a location aware client device (e.g., location aware client device 400) that may be carried by the user. Further details of operation 925 are discussed below in reference to FIG. 10. In response to detecting the user entering the personalized geo-fence, the communication module 308 may generate and transmit a message (e.g., a notification) to the device 108 being carried by the user in operation 930.

FIG. 10 is a flowchart illustrating an example method 1000 for detecting a user entering a personalized geo-fence, consistent with some embodiments. In some embodiments, the method 1000 may correspond to operation 925. The method 1000 may be embodied in computer-readable instructions for execution by one or more processors such that the steps of the method 1000 may be performed by the application server 124.

At operation 1005, location information may be received by the geo-fence module 306 from a location aware client device 400 of a subject user. The location information includes the real-world location of the location aware client device 400, which is assumed to correspond to the location of the subject user of the location aware client device 400. The location information may be transmitted to the application server 124 by a mobile location enabled application executing on the location aware client device 400 working in conjunction with the location component 490.

At operation 1010, the geo-fence module 306 may compare the location information received at operation 1005 with the personalized geo-fence location. At operation 1015, if the location of the subject user (e.g., the location of the location aware client device of the subject user) is within the virtual perimeter defining the personalized geo-fence, the subject user may be determined to have entered the personalized geo-fence.

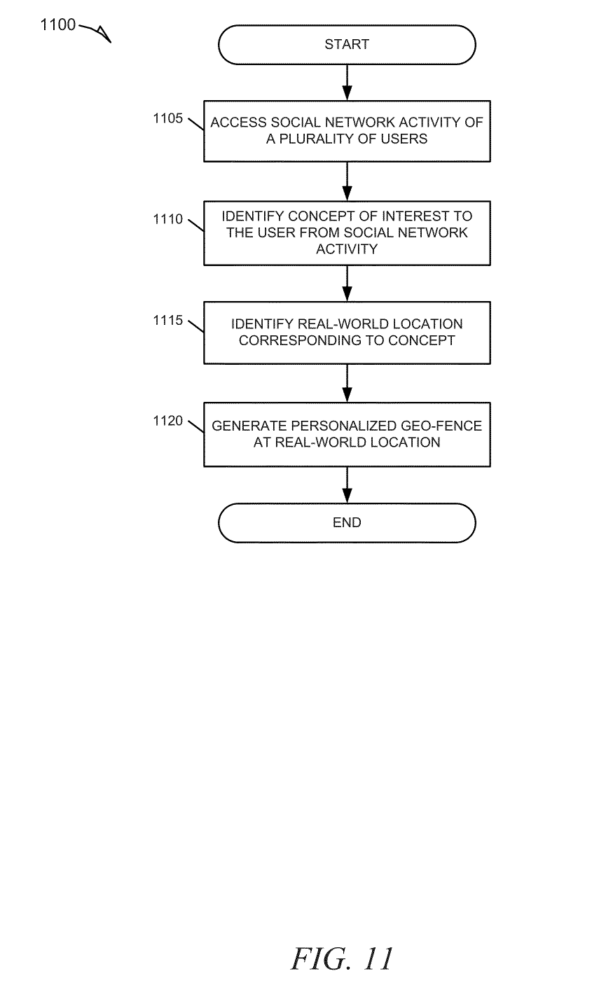

FIG. 11 is a flowchart illustrating an example method 1100 for generating and provisioning a personalized geo-fence, consistent with some alternative embodiments. The method 1100 may be embodied in computer-readable instructions for execution by one or more processors such that the steps of the method 1100 may be performed by the application server 124 and, in particular, the module 300-310 comprising the personalized geo-fence application 128.

As shown in FIG. 11, at operation 1105, the social media retrieval module 302 may obtain social network activities of a plurality of users on one or more social networks. The plurality of users may correspond to the social network connections of a user. The user of the network-based content publisher 102 may grant the network-based content publisher 102 permission to access their social networking profiles to learn more about the user. In particular, users of the network-based content publisher 102 may grant the network-based content publisher 102 permission to access a list of social network connections, which may then be stored and maintained as part of that user's user profile. The social network activity obtained by social retrieval module 302 at operation 1105 corresponds to the social network activity of each of these social network connections. The social network activity may be publicly accessible and available to be retrieved by the social media retrieval module 302 via an API provided by the applicable social network.

At operation 1110, the analysis module 304 may identify one or more concepts from the social network activity that the user may be interested in. The one or more concepts may be concepts for which one or more of the social network connections has conveyed an affinity. Because the user likely shares interests with the one or more social network connections, the concepts for which the social network connections of the users have conveyed an affinity may be concepts of interest to the user. For example, the social network activity may include a check-in to the “City Zoo” made by multiple social network connections of the user. Because multiple social network connections have checked-in at the “City Zoo,” the “City Zoo” may be of interest to the user.

At operation 1115, the geo-fence module 306 may identify a real-world location corresponding to the concept of interest to the user, and generate a personalized geo-fence for the user (e.g., the user entering the personalized geo-fence will trigger the communication of one or more messages to the user) at the real-world location at operation 1120. Following the example above, the geo-fence module 306 may generate a personalized geo-fence surrounding the “City Zoo.”

### MODULE, COMPONENTS AND LOGIC

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a FPGA or an ASIC) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware module need not be configured or instantiated at any one instance in time. For example, where the hardware modules comprise a general-purpose processor configured using software, the general-purpose processor may be configured as respective different hardware module at different times. Software may accordingly configure a processor, for example, to constitute a particular hardware module at one instance of time and to constitute a different hardware module at a different instance of time.

A hardware module can provide information to, and receive information from, other hardware module. Accordingly, the described hardware module may be regarded as being communicatively coupled. Where multiple of such hardware modules exist contemporaneously, communications may be achieved through signal transmission (e.g., over appropriate circuits and buses that connect the hardware modules). In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented module that operate to perform one or more operations or functions. The module referred to herein may, in some example embodiments, comprise processor-implemented module.

Similarly, the methods described herein may be at least partially processor-implemented. For example, at least some of the operations of a method may be performed by one or more processors or processor-implemented module. The performance of certain of the operations may be distributed among the one or more processors, not only residing within a single machine, but deployed across a number of machines. In some example embodiments, the processor or processors may be located in a single location (e.g., within a home environment, an office environment, or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, for example, a computer program tangibly embodied in an information carrier, for example, in a machine-readable medium for execution by, or to control the operation of, data processing apparatus, for example, a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site, or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

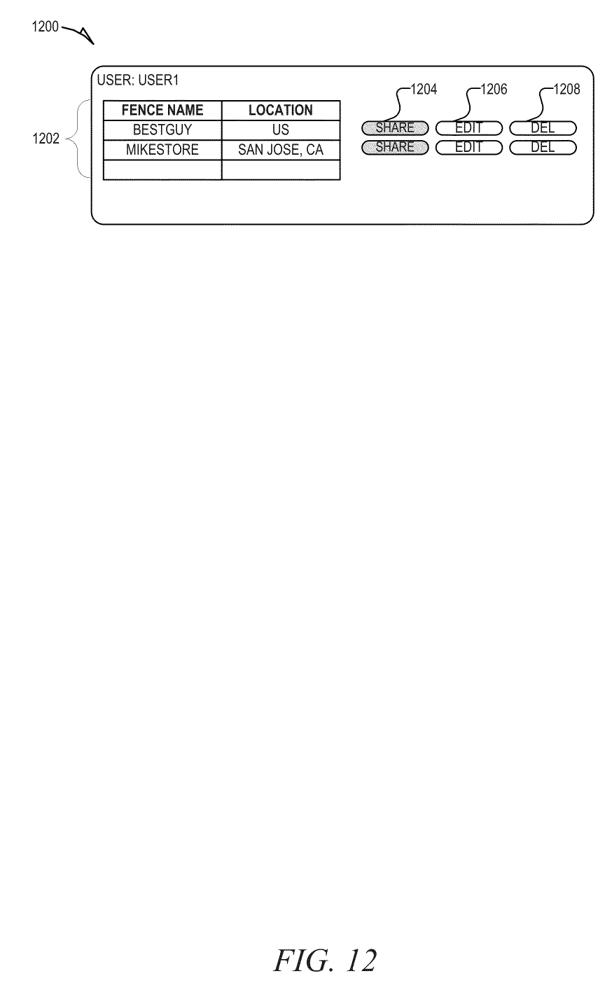

FIG. 12 is an interface diagram depicting an example personalized geo-fence view interface 1200, consistent with some embodiments. As illustrated, the personalized geo-fence view interface 1200 may include a collection 1202 of each of the personalized geo-fences of a user. As shown, the collection 1202 may include information such as a fence name and location for each personalized geo-fence. Further, the personalized geo-fence view interface 1200 may include buttons 1204, 1206, and 1208 to provide the user with the ability to share, edit, and delete personalized geo-fences, respectively. User selection of the share button 1204 may cause the communication module 308 to generate an entry on behalf of the user to be published on one or more social networks. In some embodiments, the user may be prompted to provide authorization for the communication module 308 to post the entry on his behalf. Once authorized, the shared personalized geo-fence may be added by other users to their respective collections of personalized geo-fences.

### Example Machine Architecture and Machine-Readable Medium

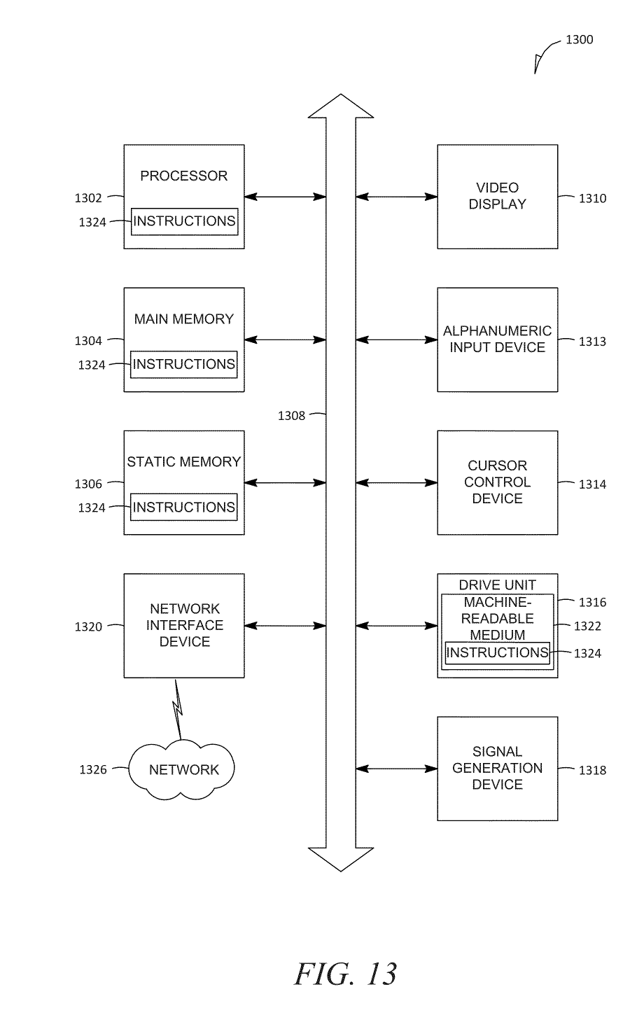

FIG. 13 is a block diagram of machine in the example form of a computer system 1300, which may correspond to client device 106 or 108, third party server 114, or server 124, consistent with some embodiments. The computer system 1300 may include instructions 1324 for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a PDA, a cellular telephone, a smart phone, a tablet, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1300 includes a processor 1302 (e.g., a central processing unit (CPU), a graphics processing unit (GPU) or both), a main memory 1304 and a static memory 1306, which communicate with each other via a bus 1308. The computer system 1300 may further include a video display unit 1310 (e.g., a liquid crystal display (LCD) or a cathode ray tube (CRT)). The computer system 1300 also includes an alphanumeric input device 1312 (e.g., a keyboard), a cursor control device 1314 (e.g., a mouse), a drive unit 1316, a signal generation device 1318 (e.g., a speaker), and a network interface device 1320.

### Machine-Readable Medium

The drive unit 1316 includes a machine-readable medium 1322 on which is stored one or more sets of data structures and instructions 1324 (e.g., software) embodying or used by any one or more of the methodologies or functions described herein. The instructions 1324 may also reside, completely or at least partially, within the main memory 1304, static memory 1306, and/or within the processor 1302 during execution thereof by the computer system 1300, with the main memory 1304 and the processor 1302 also constituting machine-readable media.

While the machine-readable medium 1322 is shown in an example embodiment to be a single medium, the term “machine-readable medium” may include a single medium or multiple media (e.g., a centralized or distributed database, and/or associated caches and servers) that store the one or more data structures or instructions 1324. The term “machine-readable medium” shall also be taken to include any tangible medium that is capable of storing, encoding, or carrying instructions (e.g., instructions 1324) for execution by the machine and that cause the machine to perform any one or more of the methodologies of the present disclosure, or that is capable of storing, encoding or carrying data structures used by or associated with such instructions. The term “machine-readable medium” shall accordingly be taken to include, but not be limited to, solid-state memories, and optical and magnetic media. Specific examples of machine-readable media include non-volatile memory, including by way of example, semiconductor memory devices (e.g., erasable programmable read-only memory (EPROM), electrically erasable programmable read-only memory (EEPROM)) and flash memory devices; magnetic disks such as internal hard disks and removable disks; magneto-optical disks; and

### CD-ROM and DVD-ROM Disks.

Furthermore, the tangible machine-readable medium is non-transitory in that it does not embody a propagating signal. However, labeling the tangible machine-readable medium as “non-transitory” should not be construed to mean that the medium is incapable of movement—the medium should be considered as being transportable from one real-world location to another. Additionally, since the machine-readable medium is tangible, the medium may be considered to be a machine-readable device.

### Transmission Medium

The instructions 1324 may further be transmitted or received over a communications network 826 using a transmission medium. The instructions 1324 may be transmitted using the network interface device 1320 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium that is capable of storing, encoding, or carrying instructions 1224 for execution by the machine, and includes digital or analog communications signals or other intangible media to facilitate communication of such software.

Although the embodiments of the present invention have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

All publications, patents, and patent documents referred to in this document are incorporated by reference herein in their entirety, as though individually incorporated by reference. In the event of inconsistent usages between this document and those documents so incorporated by reference, the usage in the incorporated references should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim. Moreover, in the following claims, the terms “first,” “second,” and “third,” and so forth are used merely as labels, and are not intended to impose numerical requirements on their objects.

What is claimed:

1. A system comprising:
a processor of a machine;
a social media module configured to access a social action performed by a user and published on one or more social networks;
an analysis module configured to determine the user has conveyed an affinity for a concept based on the social action;
a location module configured to identify a real-world location corresponding to the concept; and
a personalized geo-fence module configured to generate a personalized geo-fence for the user around the real-world location in response to determining that the user has conveyed the affinity for the concept, the personalized geo-fence being a virtual perimeter surrounding the real-world location, the virtual perimeter triggering communication of a message to the user when entered by the user.

2. The system of claim 1, wherein the personalized geo-fence module is further configured to detect the user entering the virtual perimeter.

3. The system of claim 2, further comprising a communication module configured to transmit the message to a client device of the user in response to the user entering the virtual perimeter.

4. The system of claim 3, wherein the personalized geo-fence module detects the user entering the virtual perimeter by:
receiving geo-location information from the client device of the user indicating a location of the user;
comparing the location of the user with a location of the virtual perimeter; and
determining the location of the user is within the virtual perimeter.

5. The system of claim 2, wherein the determining the user has conveyed an affinity for a concept is further based on information about the user maintained in a corresponding user profile.

6. The system of claim 3, wherein the message indicates that the user has entered the personalized geo-fence and includes at least one reward or coupon.

7. The system of claim 1, further comprising a sharing module configured to perform operations comprising:
sharing the personalized geo-fence with a group of social network connections of the user, the sharing of the personalized geo-fence enabling the group of social network connections of the user to select the personalized geo-fence;
receiving a selection of the personalized geo-fence from a social network connection of the group of social network connections, the selection of the personalized geo-fence to cause communication of a message to the social network connection in response to the social network connection entering the virtual perimeter; and
in response to the receiving of the selection of the personalized geo-fence from the social network connection, providing the user with a reward.

8. The system of claim 1, wherein the analysis module determines the user has conveyed the affinity by determining that the user has performed at least one of the following social network actions with respect to the concept: a like, a favorite, an up-vote, a+1, a share, or a post referencing the concept.

9. The system of claim 1, wherein the concept is a particular brand, and wherein the real-world location corresponds to a retail location offering products of the particular brand.

10. A method comprising accessing a social action performed by a user and published on one or more social networks;
determining the user has conveyed an affinity for a concept based on the social actions;
identifying a real-world location corresponding to the concept; and
generating a personalized geo-fence for the user around the real-world location in response to determining the user has conveyed the affinity for the concept, the personalized geo-fence being a virtual perimeter surrounding the real-world location, the virtual perimeter triggering communication of a message to the user when entered by the user.

11. The method of claim 10, further comprising
detecting the user entering the virtual perimeter; and
in response to the user entering the virtual perimeter, transmitting the message to a client device of the user.

12. The method of claim 11, wherein the detecting the user entering the virtual perimeter comprises:
receiving geo-location information from the client device of the user indicating a location of the user;
comparing the location of the user with a location of the virtual perimeter; and
determining the location of the user is within the virtual perimeter.

13. The method of claim 11, wherein the determining the user has conveyed an affinity for a concept is further based on information about the user maintained in a corresponding user profile.

14. The method of claim 11, wherein the message indicates that the user has entered the personalized geo-fence.

15. The method of claim 10, wherein the message includes a coupon.

16. The method of claim 10, further comprising:
sharing the personalized geo-fence with a group of social network connections of the user, the sharing of the personalized geo-fence enabling the group of social network connections of the user to select the personalized geo-fence;
receiving a selection of the personalized geo-fence from a social network connection of the group of social network connections, the selection of the personalized geo-fence to cause communication of a message to the social network connection in response to the social network connection entering the virtual perimeter; and
in response to receiving the selection of the personalized geo-fence from the social network connection, providing the user with a reward.

17. The method of claim 10, wherein the determining the user has conveyed the affinity for the concept comprises determining that the user has performed at least one of the following social network actions with respect to the concept: a like, a favorite, an up-vote, a+1, a share, or a post referencing the concept.

18. The method of claim 10, wherein the concept is a particular brand, and wherein the real-world location corresponds to a retail location offering products of the particular brand.

19. The method of claim 9, wherein dimensions of the virtual perimeter are set by the user.

20. A non-transitory machine-readable storage medium embodying instructions that, when executed by a machine, cause the machine to perform operations comprising:
accessing a social action performed by a user and published on one or more social networks;
identifying a concept from the a social action for which the user has conveyed an affinity;
identifying a real-world location corresponding to the concept; and
generating a personalized geo-fence for the user around the real-world location based on the conveyed affinity, the personalized geo-fence being a virtual perimeter surrounding the real-world location, the virtual perimeter to trigger communication of a message to the user when entered by the user.
